(19) United States
(12) Patent Application Publication
(10) Pub. No.: US 2010/0111165 A1
(43) Pub. Date: May 6, 2010

(54) NETWORK FLOW-BASED SCALABLE VIDEO CODING ADAPTATION DEVICE AND METHOD

(75) Inventors: Daeub KIM, Daejeon-city (KR); Jeong-Dong RYOO, Daejeon-city (KR); Sang-Min LEE, Daejeon-City (KR); Bhum-Cheol LEE, Daejeon-city (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon-city (KR)

(21) Appl. No.: 12/561,144

(22) Filed: Sep. 16, 2009

(30) Foreign Application Priority Data
Oct. 31, 2008 (KR) 10-2008-0107971

(51) Int. Cl. H04N 7/26

(52) U.S. Cl. 375/240.08; 375/E07.078

(57) ABSTRACT

Provided is a network flow-based scalable video coding (SVC) adaptation device. Without permitting a network transmitting end to divide image data into image data having various levels of quality and send the image data having the various levels of quality to all networks, since an adaptation device is installed in a network device of an ingress of a lower network of a subscriber and the adaptation device and the network transmitting end share network information about attributes of a terminal and the lower network of the subscriber so as to provide an image service having image quality corresponding to the terminal to the terminal, network efficiency can be maximized.

### CROSS-REFERENCE TO RELATED PATENT APPLICATION

This application claims the benefit of Korean Patent Application No. 10-2008-0107971, filed on Oct. 31, 2008, in the Korean Intellectual Property Office, the disclosure of which is incorporated herein in its entirety by reference.

### BACKGROUND OF THE INVENTION

1. Field of the Invention

The present invention relates to a scalable video coding (SVC) adaptation device and method.

2. Description of the Related Art

In order to properly transmit original image information to an application terminal, original image data is scalable video coded, and three-dimensional functions, spatial scalability (picture size), temporal scalability (frame rate), and signal-to-noise ratio SNR scalability (quality level), are subdivided according to the image process capability of the application terminal. The scalable video coded image data is adapted and reconstructed to have a bandwidth, which is related to bit rate, frame rate, and resolution, suitable for the application terminal, packetized into an Internet protocol/user datagram protocol/real-time transport protocol (IP/UDP/RTP) packet or any other streaming protocol packet, and transmitted to a network.

The adapting of the original image data to have the bandwidth suitable for the application terminal and a subscriber area network that provides an image service is performed by generating a base layer and a plurality of enhancement layers from the original image data according to the characteristics of scalable video coding (SVC). The base layer refers to a layer that is compatible with H.264/AVC and can be independently used to provide the image service. The plurality of enhancement layers are layers that are obtained by layering the original image data based on three-dimensional (3D) functions. As the number of enhancement layers in addition to the base layer increases, the image service having more improved 3D functions, i.e., spatial scalability (picture size), temporal scalability (frame rate), and SNR scalability (quality level), can be provided by the application terminal.

However, during the course of the provision of the image service by the application terminal, since a plurality of images having different bandwidths (capacities) and attributes are generated from one original image in whole networks, bandwidth profile management becomes difficult, and network expansion is necessary to process the different bandwidths, thereby increasing equipment investment expenses and management fees.

### SUMMARY OF THE INVENTION

The present invention provides a network flow-based scalable video coding (SVC) adaptation method that can effectively reduce the bandwidth of a scalable video coded image data packet to a desired bandwidth in order to provide an image service suitable for a terminal or the service capacity of a lower network, and a network flow-based SVC adaptation device using the network flow-based SVC adaptation method.

Without permitting a network transmitting end to divide image data into image data having various levels of quality and send the image data having the various levels of quality to all networks, since an adaptation device is installed in a network device, e.g., an access router, a switch, or a set-top box, of an ingress of a network of a subscriber, and since the adaptation device and the network transmitting end share network information about attributes of a terminal and the network of the subscriber so as to provide an image service having image quality corresponding to the terminal to the terminal, network efficiency can be maximized.

According to an aspect of the present invention, there is provided a network flow-based scalable video coding (SVC) adaptation device including: an SVC adapting unit selecting scalable video coded image data according to attributes of image quality of a terminal based on network information shared with a network transmitting end, from a streaming packet having the best quality received from the network transmitting end; and a packet inspection processing unit updating information about the streaming packet with information about a new streaming packet including the selected scalable video coded image data.

According to another aspect of the present invention, there is provided an apparatus for transmitting scalable video coded image data to a network device that transmits a scalable video coded image service to a network to which one or more terminals belong, the apparatus including a layer adapting unit generating an image information control packet including a mapping relationship between image data layer identification information and attributes of image quality of a terminal which is shared with the network device, and generating a streaming packet having the best quality, which is layered by reflecting the image data layer identification information and the attributes of the image quality of the terminal, from original image data.

According to another aspect of the present invention, there is provided a network flow-based SVC adaptation method including: receiving a streaming packet having the best quality from a network transmitting end; selecting scalable video coded image data according to attributes of image quality of a terminal, from the streaming packet based on network information shared with the network transmitting end; and updating information about the streaming packet with information about a new streaming packet including the selected scalable video coded image data.

According to another aspect of the present invention, there is provided a method of transmitting scalable video coded image data to a network device that transmits a scalable video coded image service to a network to which one or more subscriber terminals belong, the method including: generating an image information control packet including a mapping relationship between image data layer identification information and attributes of image quality of a terminal which is shared with the network device; and generating a streaming packet having the best quality, which is layered by reflecting the image data layer identification information and the attributes of the image quality of the terminal, from original image data.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B illustrate a case where image data is layered based on scalable video coding (SVC);

FIG. 2 illustrates a header of an SVC network abstraction layer (NAL) unit for carrying scalable video coded image data in a payload of a real-time transport protocol (RTP) packet;

FIG. 3 illustrates a case where scalable video coded image data is transmitted to a subscriber area in a conventional SVC network system;

FIG. 4 illustrates a case where scalable video coded image data is transmitted to a subscriber area, according to an embodiment of the present invention;

FIG. 5 illustrates a mapping table in which image information obtained by layering scalable video coded image data is mapped to image information in a header of an NAL unit, according to an embodiment of the present invention;

FIG. 6 is a block diagram of a network flow-based SVC adaptation device, according to an embodiment of the present invention;

FIG. 7 is a flowchart illustrating a packet-based SVC adaptation method of a packet-based SVC adapting unit of the network flow-based SVC adaptation device of FIG. 6, according to an embodiment of the present invention;

FIG. 8 is a flowchart illustrating a method of hierarchically transmitting scalable video coded image data to a network device that transmits a scalable video coded image service to a lower network by using a network transmitting end, according to an embodiment of the present invention.

### DETAILED DESCRIPTION OF THE INVENTION

The present invention will now be described more fully with reference to the accompanying drawings, in which exemplary embodiments of the invention are shown. Although the same elements are shown in different drawings, like reference numerals in the drawings denote like elements. Detailed explanation will not be given when it is determined that detailed explanation about well-known function and configuration of the present invention may obscure the point of the present invention.

Unless the context dictates otherwise, the word “comprise” or variations such as “comprises” or “comprising” is understood to mean “includes, but is not limited to” such that other elements that are not explicitly mentioned may also be included. The term “unit”, “module”, “block”, or the like in the embodiments of the present invention means a unit that performs at least one function or operation, and may be realized by hardware, software, or a combination thereof.

The present invention relates to a network flow-based scalable video coding (SVC) adaptation device and method which can reduce complexity and traffic caused by image data having various levels of quality derived from one original image in a network that provides a scalable video coded image service and effectively process and manage scalable video coded image data using a network device.

Without permitting a network transmitting end to divide scalable video coded image data into scalable video coded image data having various levels of quality and sending the image data having the various levels of quality to all networks, since scalable video coded image data having the best quality for each service used in a network of a subscriber is transmitted to the network, an adaptation device is installed in a network device, e.g., an access router, a switch, or a set-top box, of an ingress of the network of the subscriber so as to process the scalable video coded image data having the best quality in the network device, and the adaptation device and the network transmitting end share network information about attributes of a terminal and the network of the subscriber that provides an image service, unnecessary network bandwidth waste can be prevented, complex packet management elements can be removed, and network efficiency can be maximized.

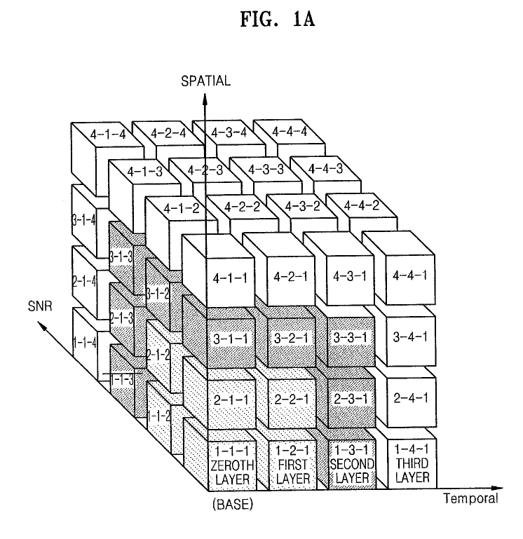

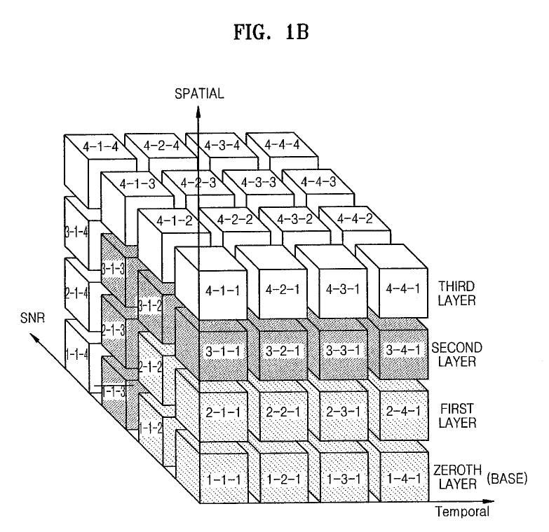

FIGS. 1A and 1B illustrate a case where image data is layered based on SVC. Image quality of an original image may be represented as a data cube (tier) that a 3-dimensional (3D) array of layers. The quality of an image service varies according to a combination of the layers of the data cube. An image having the best quality, which is similar to the original image, may be provided when all of the layers of the data cube are combined.

In FIG. 1A, zeroth through third layers are generated in a temporal direction, and in FIG. 1B, zeroth through third layers are generated in a spatial direction. Image data may be layered into layers in various ways as shown in FIGS. 1A and 1B according to image service characteristics, such as picture size, frame rate, and quality, by collecting information about the capability of an image service of a terminal and the bandwidth of a network of a subscriber.

Image data including enhanced layers and a base layer including network information about a network of a subscriber is packetized in network abstraction layer (NAL) units. Each of the NAL units constitutes a payload of a real-time transport protocol (RTP) packet or of any other streaming protocol packet. The NAL unit(s) may be aggregated into an RTP packet or any other streaming protocol packet using a single NAL unit (SNU), simple-time aggregation packet-A (STAP-A), simple-time aggregation packet-B (STAP-B), multi-time aggregation packet 16 (MTAP 16), multi-time aggregation packet 24 (MTAP 24), fragmentation unit-A (FU-A), fragmentation unit-B (FU-B), and the like. In this case, one NAL unit may be aggregated into an RTP packet or any other streaming protocol packet, or a plurality of NAL units may be aggregated into an RTP packet or any other streaming protocol packet.

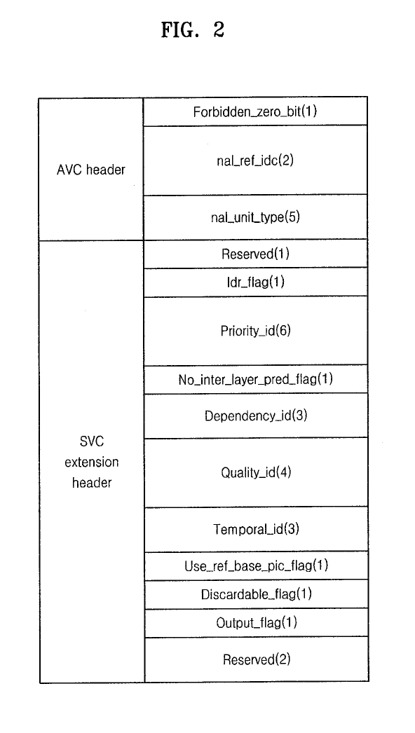

FIG. 2 illustrates a header of an SVC NAL unit for carrying scalable video coded image data in a payload of an RTP packet or any other streaming protocol packet.

The header of the SVC NAL unit includes an AVC header and an SVC extension header. The SVC extension header includes layer identification information, i.e., ID identification information about 3D functions that determine SVC quality, such as a spatial layer level, a temporal layer level, and a quality layer level, and priority ID information such as a priority level.

As shown in the SVC extension header, 8 (2̂3) combinations may be made based on dependency scalability and spatial scalability (picture resolution), 8 (2̂3) combinations may be made based on temporal scalability (frame rate), and 16 (2̂4) combinations may be made based on SNR scalability (quality level). Accordingly, original image data may be edited as 8*8*16 (=1024) data cubes. Also, as shown in a Priority_id field, 2̂6 (=64) priorities may be given.

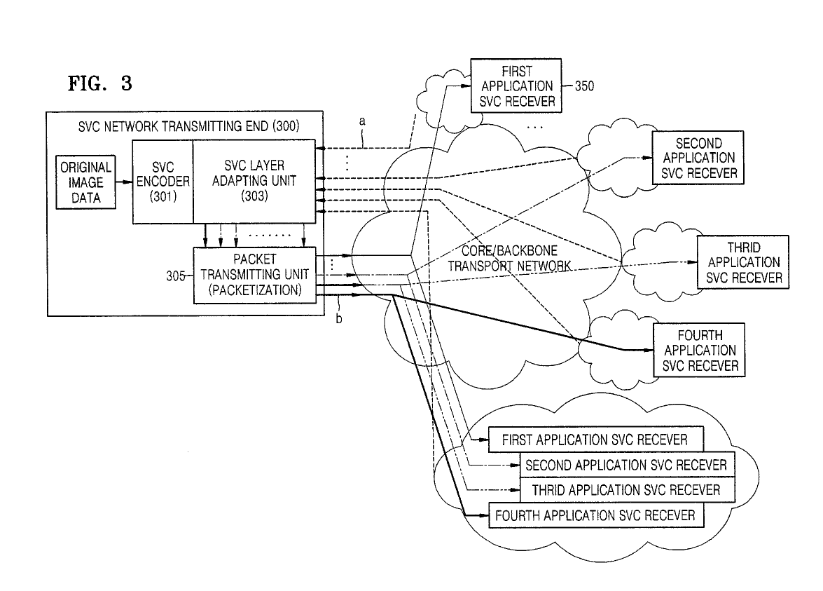

FIG. 3 illustrates a case where scalable video coded image data is transmitted to a subscriber area in a conventional SVC network system.

Referring to FIG. 3, the conventional SVC network system includes a network transmitting end 300 transmitting scalable video coded image data to network areas, and a plurality of SVC receivers 350, i.e., first through fourth application SVC receivers, selectively receiving image data packets that are suitable for terminals according to their characteristics through a core/backbone transport network. The network transmitting end 300 collects attributes of terminals and networks used to provide an image service from all networks of subscribers, generates image data having different capacities (bandwidths) from one piece of original image data by varying 3D functions, i.e., spatial capability (picture resolution), temporal scalability (frame rate), and SNR scalability (quality level), and transmits the image data having the different capacities (bandwidths) to networks that require the image data.

The network transmitting end 300 includes an SVC encoder 301, an SVC layer adapting unit 303, and a packet transmitting unit 305. The SVC encoder 301 performs SVC on original image data to obtain scalable video coded image data. The layer adapting unit 303 layers the scalable video coded image data in NAL units based on network information about the image quality of image service of a terminal and a network of a subscriber which is used to provide the image service. The packet transmitting unit 305 packetizes the layered scalable video coded image data into an Internet protocol/user datagram protocol/real-time transport protocol (IP/UDP/RTP) packet or any other streaming protocol packet and transmits the IP/UDP/RTP packet or the other streaming protocol packet as shown in flow “b”.

The SVC receivers 350 individually transmit information about image quality to the network transmitting end 300 that is a server as shown in flow “a”.

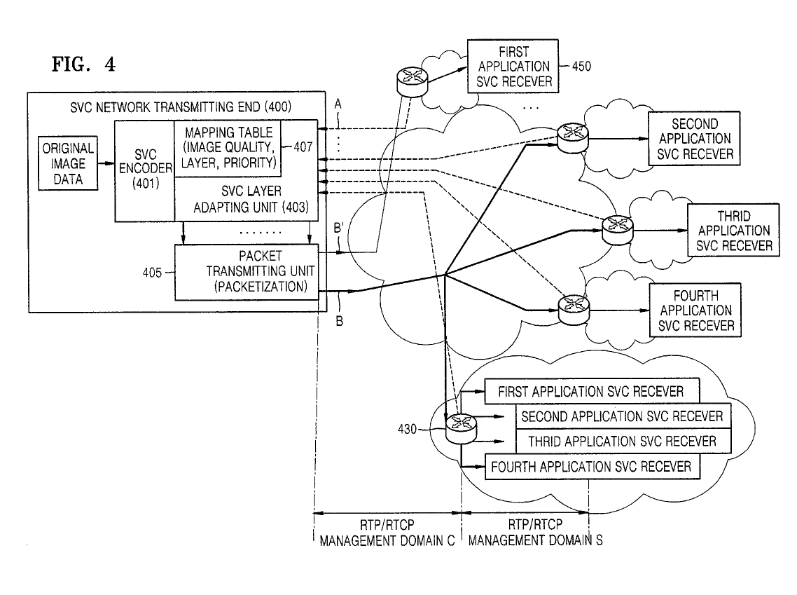

FIG. 4 illustrates a case where scalable video coded image data is transmitted to a subscriber area, according to an embodiment of the present invention.

Referring to FIG. 4, an SVC network system includes a network transmitting end 400, a network device 430, and a plurality of SVC receivers 450, i.e., first through fourth application SVC receivers.

The network transmitting end 400 is a device that transmits a scalable video coded image service having the best quality to a network of a subscriber to which a terminal belongs. The network transmitting end 400 may be the same as a network transmitting end used in the related art. The network transmitting end 400 may transmit an image service having the best quality as shown in flow B or transmit an image service having image quality corresponding to each subscriber to the subscriber as shown in flow B′.

The network transmitting end 400 includes an SVC encoder 401, a layer adapting unit 403, and a packet transmitting unit 405.

The SVC encoder 401 performs SVC on original image data to obtain scalable video coded image data.

The layer adapting unit 403 layers the scalable video coded image data in NAL units to obtain layered scalable video coded image data. The layer adapting unit 403 performs SVC adaptation on the layered scalable video coded image data based on network information about the terminal and the network of the subscriber which is used to provide an image service to obtain image data having the best quality. The layer adapting unit 403 generates and manages a mapping table 407 that maps attributes of image quality of the terminal and the network quality to SVC layer identification information, and shares the mapping table with the network device 430.

The packet transmitting unit 405 packetizes the image data having the best quality into an IP/UDP/RTP packet or any other streaming protocol packet and transmits the IP/UDP/RTP packet or the other streaming protocol packet to the network.

The network device 430 may directly operate RTP (or any other streaming protocol)/RTCP domains between the terminal and the network transmitting end 400 that is a server, and may separate and manage the domains. The network device 430 performs RTP (or any other streaming protocol)/RTCP packet adaptation on a packet of scalable video coded image data suitable for image quality of the terminal, and generates new RTP (or any other streaming protocol)/RTCP domains for supporting scalable video coded image data of various layers for various levels of quality and for multicasting/broadcasting one image service in the network.

Since two management domains, that is, a management domain C and a management domain S, are used, terminals don't need to individually send information about image quality to the network transmitting end 400, and the network device 430 notifies the network transmitting end 400 about the attributes of the image quality of the terminal and the network as shown in flow A. The network device 430 shares the mapping table 407 with the network transmitting end 400, thereby making it possible to realize a network flow-based SVC adaptation device.

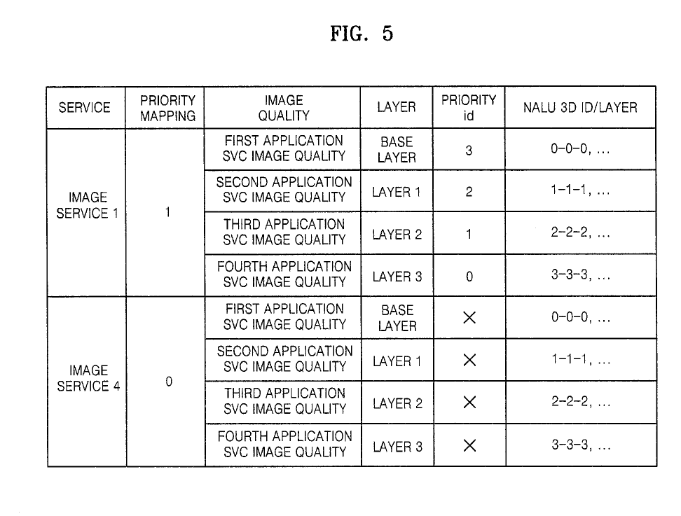

FIG. 5 is a mapping table showing that image information obtained by layering scalable video coded image data is mapped to image information in a header of an NAL unit, according to an embodiment of the present invention.

The mapping table shows that a dependency ID (a spatial layer level), a temporal ID (a temporal layer level), a scalability ID (a quality layer level) and a priority ID (a priority level) of the header of the NAL unit are mapped to the layered scalable video coded image data. A network transmitting end and a network flow-based SVC adaptation device of a network device share the mapping table. Layering suitable for the image quality of a terminal and a network used to provide an image service is performed, and a 3D ID, i.e., the dependency ID, the temporal ID, and the scalability ID, of the NAL unit for the layering is reflected in the mapping table. The network flow-based SVC adaptation device performs priority mapping for simple network adaptation so as to determine information about the layering from the priority ID of the header of the NAL unit. When priority and layering are mapped to each other, 1 is set to a priority mapping field. Lists of the mapping table are classified according to image services.

Since the network device including the network flow-based SVC adaptation device shares the mapping table with the network transmitting end, the network device may directly perform adaptation to obtain the image quality of the terminal which is necessary for the network of the subscriber, and obtain the necessary image quality by using only one type of scalable video coded image data having a large bandwidth which is layered to have the best quality from an upper network connected to the network transmitting end that is a server. Accordingly, network complexity, management difficulty, and management fees can be reduced.

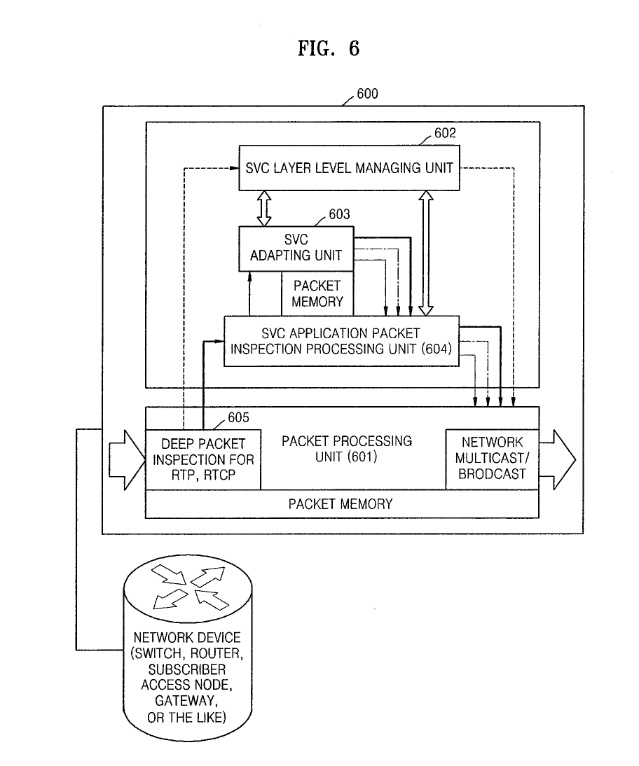

FIG. 6 is a block diagram of a network flow-based SVC adaptation device 600, according to an embodiment of the present invention.

A packet having image data as a payload is referred to as a streaming packet, and a packet having control information as a payload is referred to as an image information control packet. Although an RTP packet is exemplarily described for convenience of explanation, the present invention is not limited thereto and various streaming packets may be used.

Referring to FIG. 6, the SVC adaptation device 600 is mounted in a network device such as a switch, a router, a subscriber access node, or a gateway. The SVC adaptation device 600 includes a packet processing unit 601, an SVC layer level managing unit 602, an SVC adapting unit 603, and an SVC application packet inspection processing unit 604.

The packet processing unit 601 includes a deep packet inspection unit 605 that is installed in an ingress and classifies packets received from a transmitting end into a streaming packet and an image information control packet including network information. All packets entering the network device pass through the deep packet inspection unit 605 of the packet processing unit 601. The deep packet inspection unit 605 may obtain information of a packet header, such as an RTP (or any other streaming protocol)/RTCP, a link layer L2, a network layer L3, a transport layer L4 (UDP, TCP, or any other transport network protocol) RTP/RTCP and SVC loads. The deep packet inspection unit 605 classifies the RTP (or any other streaming protocol)/RTCP packet and an image information control packet related to a mapping table that maps image data layer identification information included in a header of an NAL unit to layered scalable video coded image data. The image information control packet is transmitted to the SVC layer level managing unit 602, the RTP/RTCP packet having scalable video coded image data as a payload is transmitted to the SVC application packet inspection processing unit 604, and remaining packets are stored in a packet memory and are processed by the packet processing unit 601 according to switching and routing rules. The packet processing unit 601 receives a new RTP packet from the SVC application packet inspection processing unit 604 and transmits the new RTP packet to a corresponding terminal by multicasting or broadcasting.

The SVC layer level managing unit 602 collects information about each image service from the image information control packet, and generates and manages the mapping table as network information. The mapping table is generated by extracting a mapping relationship between the image data layer identification information and attributes of image quality of a terminal, from the image information control packet. The SVC layer level managing unit 602 separates a management domain into a plurality of management domains and manages the plurality of management domains. For example, if the SVC layer level managing unit 602 receives an image service request from a terminal, the SVC layer level managing unit 602 processes the image service request. In detail, if the requested image service is a previously received image service, the SVC layer level managing unit 602 may provide an image service having image quality corresponding to the terminal to the terminal without transmitting a separate image service request to a network transmitting end. If the requested image service is a new image service, the SVC layer level managing unit 602 may generate a new request message and transmit the new request message to the network transmitting end. The new image service received by the SVC adaptation device 600 from the network transmitting end in response to the new request message is adapted to have image quality according to the attributes of the terminal and is transmitted to the terminal.

The SVC application packet inspection processing unit 604, which updates information of a streaming packet with information of a new streaming packet including selected image data, receives and processes the RTP (or any other streaming protocol)/RTCP packet having the layered scalable video coded image data as the payload. The SVC application packet inspection processing unit 604 modifies and updates metadata, length, sequence, and timestamp information related to the RTP (or any other streaming protocol)/RTCP packet so that scalable video coded image data layered by the packet-based SVC adapting unit 603 to have the best quality is adapted to be suitable for the terminal managed by the network device.

The packet-based SVC adapting unit 603 selects a unit, e.g., an NAL unit, of scalable video coded image data that is layered according to attributes of image quality of each terminal based on network information that is shared with the network transmitting end from a streaming packet having the best quality received from the network transmitting end in order to provide an image service to the network to which one or more terminals belong. The packet-based SVC adapting unit 603 selects image data having image data layer identification information, corresponding image quality of the terminal that is obtained from the network information, from the streaming packet. The packet-based SVC adapting unit 603 adapts the scalable video coded image data having a large bandwidth which is layered to have the best quality based on the mapping table of the SVC layer level managing unit 602 to be suitable for the network. The adaptation is performed based on priority ID information and ID information about 3D functions that determine SVC quality of an SVC extension header. The priority ID information and the ID information about the 3D functions are image data layer identification information including a spatial layer level, a temporal layer level, a quality layer level, and a priority level. Packets are stored in the packet memory during operation of the packet-based SVC adapting unit 603 and the SVC application packet inspection processing unit 604.

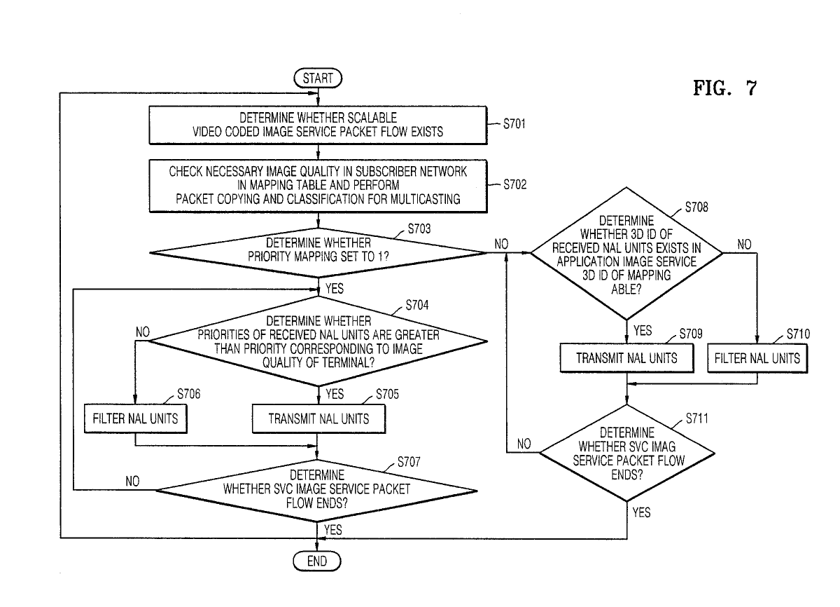

FIG. 7 is a flowchart illustrating a packet-based SVC adaptation method of the packet-based SVC adapting unit 603 of the network flow-based SVC adaptation device 600 of FIG. 6.

In operation S701, it is determined whether a scalable video coded image service packet flow exists. If it is determined that the scalable video coded image service packet flow exists, the method proceeds to operation S702. In operation S702, necessary image quality in a lower network is checked by checking a mapping table. If different terminals requiring various levels of image quality exist in the lower network, a service having the various levels of image quality should be provided. Hence, packet copying and classification for multicasting are performed. A received packet is a streaming packet having the best quality transmitted from a network transmitting end in order to provide an image service to a network to which one or more terminals belong. Scalable video coded image data which is layered according to attributes of image quality of a terminal is selected from the streaming packet based on network information shared with the network transmitting end. Also, a mapping table is generated and managed by extracting the network information providing a mapping relationship between image data layer identification information and attributes of image quality of the terminal from an image information control packet that is received from the network transmitting end. The scalable video coded image data is selected by selecting image data having image data layer identification information, corresponding to the image quality of the terminal obtained from the network information, from the streaming packet. A priority corresponding to the image quality of the terminal is checked from the network information, and image data having a priority that is greater than the checked priority is selected. If no priority is mapped to the image data selected from the streaming packet, image data having a combination of a spatial layer level, a temporal layer level, and a quality layer level in the network information, corresponding to the image quality of the terminal, is selected.

For example, in operation S703, it is determined whether a priority mapping of NAL units of scalable video coded image data having a large bandwidth which is layered to have the best quality after checking and copying end, is set to ‘1’.

If it is determined in operation S703 that the priority mapping is set to ‘1’, the method proceeds to operation S704. In operation S704, priorities of the NAL units are obtained and filtered. As a priority increases, a layer gets closer to a base layer. In operation S705, headers of the NAL units are inspected and only NAL units having priorities that are greater than the priority of the terminal checked in operation S702 are transmitted. In operation S706, NAL units having priorities that are less than the priority of the terminal checked in operation S702 are filtered and discarded. In operation S707, NAL unit filtering is continued until the SVC image service packet flow ends.

If it is determined that the priority mapping is set to ‘0’, the method proceeds to operation S708. In operation S708, headers of the NAL units are inspected and it is determined whether a 3D ID of the NAL units exists in an application image service 3D ID of the mapping table.

If it is determined in operation S708 that the 3D ID of the NAL units exists in the application image service 3D ID of the mapping table, the method proceeds to operation S709. In operation S709, the NAL units are transmitted. If it is determined in operation S708 that the 3D ID of the NAL units does not exist in the application image service 3D ID of the mapping table, the method proceeds to operation S710. In operation S710, the NAL units necessary to additionally improve image quality are filtered and discarded. In operation S711, NAL unit filtering is continued until the SVC image service packet flow ends.

A layered scalable video coded NAL unit passing through the packet-based SVC adapting unit 603 is classified as an NAL unit having image quality suitable for each terminal of a subscriber area by the packet-based SVC adapting unit 603. New packetization is performed by the SVC application packet inspection processing unit 604. Metadata, length, sequence, and timestamp information related to an RTP(or any other streaming protocol)/RTCP packet is modified and updated by the SVC application packet inspection processing unit 604 and then transmitted with the new packet to the packet processing unit 601.

Network multicasting/broadcasting is performed by an output end 607 in accordance with the number of terminals for one image quality, to provide an image service having image quality suitable for a subscriber to the subscriber.

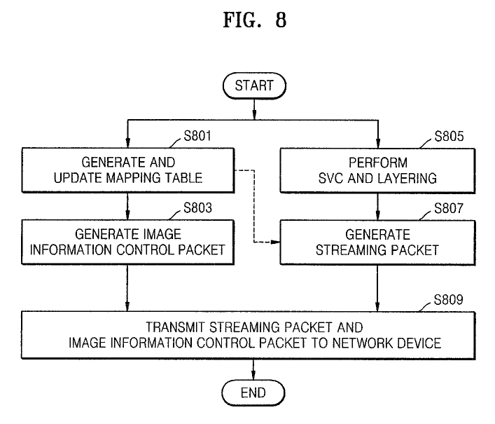

FIG. 8 is a flowchart illustrating a method of hierarchically transmitting scalable video coded image data to a network device that transmits a scalable video coded image service to a lower network by using a network transmitting end, according to an embodiment of the present invention.

In operation S801, the network transmitting end receives image quality information, such as a bandwidth of a network of a subscriber, generates a mapping table showing that attributes of image quality of the terminal are mapped to image data layer identification information, and updates the mapping table with an information change request, such as an additional image quality or a bandwidth change request, of the network to which a terminal belongs. In operation S803, an image information control packet is generated as a control signal in order to share information of the mapping table with an SVC adaptation device of a network device. In operation S809, the image information control packet is transmitted to the network device.

In operation S805, the network transmitting end scalable video codes original image data in order to provide an image service to the network to which one or more terminals belong, and layers the scalable video coded image data. In operation S807, a streaming packet having the best quality is generated based on the mapping table. In operation S809, the streaming packet is transmitted to the network device.

As described above, according to the present invention, in a network providing a scalable video coded image service, a network flow-based SVC adaptation device is mounted in a network device, such as a packet router, a switch, a subscriber access node, or a gateway, which supports transportation or access to a lower network of a specific area or a specific use.

Since the network flow-based SVC adaptation device is used, the network device directly performs adaptation to have scalable video coded image quality of a terminal which is necessary for a network of a subscriber, receives scalable video coded image data having a large bandwidth which is layered to have the best quality from a higher network connected to a network transmitting end that is a server, and provides image quality necessary for a plurality of terminals to the plurality of terminals. Accordingly, network complexity, management difficulty, and maintenance fees can be reduced.

Since image traffic is effectively managed by using SVC characteristics on image services that have various bandwidths and are expected to be in very high demand, various image service quality suitable for different terminals can be provided to the different terminals in the form of video on demand (VOD) or broadcasting.

In alternative embodiments, hardware may be used in place of or in combination with a process/controller programmed with computer software instructions to implement the invention. Thus, the embodiments of the invention are not limited to any specific combination of hardware circuitry and software.

The present invention can be embodied as computer-readable codes on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network coupled computer systems so that the computer-readable code is stored and executed in a distributed fashion.

Accordingly, while the present invention has been particularly shown and described with reference to exemplary embodiments thereof, it will be understood by those of ordinary skill in the art that various changes in form and detail may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A network flow-based scalable video coding (SVC) adaptation device comprising:
an SVC adapting unit selecting scalable video coded image data according to attributes of image quality of a terminal based on network information shared with a network transmitting end, from a streaming packet having the best quality received from the network transmitting end; and
a packet inspection processing unit updating information about the streaming packet with information about a new streaming packet including the selected scalable video coded image data.

2. The network flow-based SVC adaptation device of claim 1, further comprising:
a packet processing unit classifying packets received from the network transmitting end into the streaming packet and an image information control packet including the network information; and
an SVC layer level managing unit generating and managing the network information by extracting a mapping relationship between attributes of image quality of a terminal and image data layer identification information from the image information control packet.

3. The network flow-based SVC adaptation device of claim 1, wherein the SVC adapting unit selects an image data unit having image data layer identification information, corresponding to image quality of a terminal, which is obtained based on the network information, from the streaming packet.

4. The network flow-based SVC adaptation device of claim 3, wherein the image data layer identification information comprises a priority level, a spatial layer level, a temporal layer level, and a quality layer level.

5. The network flow-based SVC adaptation device of claim 1, wherein, in a network providing a scalable video coded image service, the network flow-based SVC adaptation device is mounted in a network device that supports transportation of the scalable video coded image service to a lower network of a specific area or for a specific use.

6. The network flow-based SVC adaptation device of claim 1, wherein attributes of image quality of each of the one or more terminals and the network are transmitted to the network transmitting end.

7. An apparatus for transmitting scalable video coded image data to a network device that transmits a scalable video coded image service to a network to which one or more terminals belong, the apparatus comprising
a layer adapting unit generating an image information control packet including a mapping relationship between image data layer identification information and attributes of image quality of a terminal which is shared with the network device, and generating a streaming packet having the best quality, which is layered by reflecting the image data layer identification information and the attributes of the image quality of the terminal, from original image data.

8. The SVC image service transmission device of claim 7, wherein the image data layer identification information comprises a priority level, a spatial layer level, a temporal layer level, and a quality layer level.

9. The SVC image service transmission device of claim 7, wherein the layer adapting unit receives attributes of image quality of each of the one or more terminals and the network quality from the network device, and updates the mapping relationship.

10. A network flow-based SVC adaptation method comprising:
receiving a streaming packet having the best quality from a network transmitting end;
selecting scalable video coded image data according to attributes of image quality of a terminal, from the streaming packet based on network information shared with the network transmitting end; and
updating information about the streaming packet with information about a new streaming packet including the selected scalable video coded image data.

11. The network flow-based SVC adaptation method of claim 10, further comprising extracting the network information, which provides a mapping relationship between attributes of image quality of a terminal and image data layer identification information, from an image information control packet received from the network transmitting end, and managing the network information.

12. The network flow-based SVC adaptation method of claim 10, wherein the selecting of the scalable video coded image data comprises selecting an image data unit having image data layer identification information corresponding to image quality of a terminal, which is obtained from the network information, from the streaming packet.

13. The network flow-based SVC adaptation method of claim 12, wherein the image data layer identification information comprises a priority level, a spatial layer level, a temporal layer level, and a quality layer level.

14. The network flow-based SVC adaptation method of claim 10, wherein the selecting of the scalable video coded image data comprises:
checking a priority corresponding to the image quality of the terminal from the network information; and
selecting image data having a priority, which is greater than the checked priority, from the streaming packet.

15. The network flow-based SVC adaptation method of claim 14, wherein, if a priority is not mapped to image data of the streaming packet, the method further comprises selecting image data having a combination of a spatial layer level, a temporal layer level, and a quality layer level in the network information.

16. A method of transmitting scalable video coded image data to a network device that transmits a scalable video coded image service to a network to which one or more subscriber terminals belong, the method comprising:
generating an image information control packet including a mapping relationship between image data layer identification information and attributes of image quality of a terminal which is shared with the network device; and
generating a streaming packet having the best quality, which is layered by reflecting the image data layer identification information and the attributes of the image quality of the terminal, from original image data.

17. The SVC image service transmission method of claim 16, wherein the image data layer identification information comprises a priority level, a spatial layer level, a temporal layer level, and a quality layer level.

18. The SVC image service transmission method of claim 16, further comprising receiving attributes of image quality of each of the one or more terminals and the network quality from the network device and updating the mapping relationship.
